(19) United States
(12) Patent Application Publication
(10) Pub. No.: US 2018/0320796 A1
(43) Pub. Date: Nov. 8, 2018

(54) NEGATIVE PRESSURE BACKFLOW PREVENTION APPARATUS

(71) Applicants: Ming-Te Hung, New Taipei City (TW); Kun-Sheng Huang, New Taipei City (TW)

(72) Inventors: Ming-Te Hung, New Taipei City (TW); Kun-Sheng Huang, New Taipei City (TW)

(21) Appl. No.: 15/587,383

(22) Filed: May 4, 2017

(51) Int. Cl. F16K 15/14

(52) U.S. Cl. CPC F16K 15/147

(57) ABSTRACT

A negative pressure backflow prevention apparatus includes a base having one end formed of at least one air inlet, a supporting portion and a first connecting portion arranged at predefined locations of the base; the least one air inlet penetrating into another end of the base; and a sealing member having one end formed of a second connecting portion and another end formed of an air outlet; and the second connecting portion and the first connecting portion connected to each other in order to seal another end of the air inlet; the supporting portion penetrating through the air outlet and attached onto the air outlet and the supporting portion. Accordingly, the negative pressure backflow prevention apparatus of the present invention is able to achieve the effects of preventing deformations of the apparatus and preventing negative backflows.

### (a) TECHNICAL FIELD OF THE INVENTION

The present invention is related to a negative pressure backflow prevention apparatus, in particular, to an apparatus equipped with a sealing member for effectively preventing negative pressure backflow and a supporting portion for effectively supporting the sealing member in order to prevent the deformation of the sealing member.

### (b) DESCRIPTION OF THE PRIOR ART

In general, to effectively prevent gas or liquid backflows, a non-return valve is typically installed at inlet of the gas or liquid in order to effectively prevent the backflows of gas or liquid. During the process of preventing the return flows, to prevent the generation of backflows, the head portion of the non-return valve is typically of a cone shape, and an opening is formed at the top end of the cone in order to effectively achieve the return prevention effect. Nevertheless, if the pressure of the gas backflow is too high, the backflow pressure tends to continuously press onto the two sides of the opening such that it is likely to generate deformation to cause leakages.

In view of the aforementioned drawback, currently, it is known that U.S. Pat. No. 8,276,616 B2 “High Pressures Duckbill Valve and Insert” discloses a device as shown in FIG. 1 of the patent, which mainly comprises a duckbill valve 11, a valve seat 12 and a supporting member 13. One end of the duckbill valve 11 includes an air outlet 111, and the supporting member 13 is installed at the internal of the duckbill valve 11 in order to support the two sides of the internal of the duckbill valve 11 such that the mechanical strength of the duckbill valve is effectively increased.

Nevertheless, since the supporting member merely supports the two sides of the internal of the duckbill valve, the outlet portion formed on the duckbill valve and parts of the duckbill still cannot obtain effective and firm supports from the supporting member.

### SUMMARY OF THE INVENTION

To achieve the aforementioned objectives, the present invention provides a negative pressure backflow prevention apparatus, comprising a base having one end formed of at least one air inlet, a supporting portion and a first connecting portion arranged at predefined locations of the base; the least one air inlet penetrating into another end of the base; and a sealing member having one end formed of a second connecting portion and another end formed of an air outlet; and the second connecting portion and the first connecting portion connected to each other in order to seal another end of the air inlet; the supporting portion penetrating through the air outlet and attached onto the air outlet and the supporting portion.

According to an embodiment of a negative pressure backflow prevention of the present invention, the base and the sealing member are further installed at an internal of an air guide in order to effectively guide a gas to a predefined location via the air guide.

According to an embodiment of a negative pressure backflow prevention of the present invention, an internal of the sealing member includes a hollow space.

According to an embodiment of a negative pressure backflow prevention of the present invention, a vertical cross-sectional profile the sealing member has a shape of any one of a triangle, rectangle and a trapezoid.

According to an embodiment of a negative pressure backflow prevention of the present invention, a center of the base is formed of the supporting portion and the first connecting portion.

According to an embodiment of a negative pressure backflow prevention of the present invention, horizontal cross-sectional profile of the base has a shape of any one of a circle, a triangle, a rectangle and a star.

### BRIEF DESCRIPTION OF THE DRAWINGS

FIG. 1 is a cross-sectional view of a prior art;

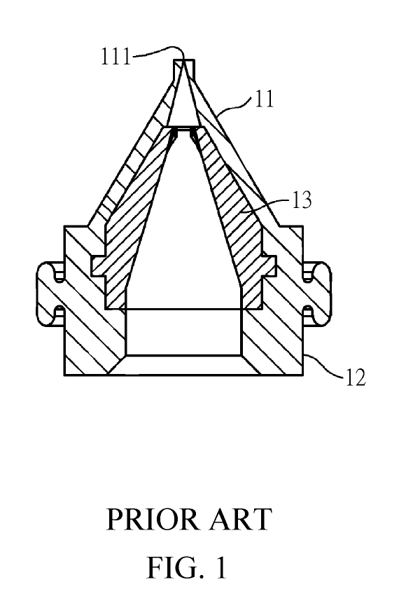

FIG. 2 is a perspective view of the present invention;

FIG. 3 is an exploded view of the present invention;

FIG. 4 is a cross-sectional view of the present invention;

FIG. 5 is an exploded view showing a state of use of the present invention;

FIG. 6 is a schematic view showing a state of use of the present invention;

FIG. 7 is a schematic view showing the air intake of the present invention;

FIG. 8 is schematic view showing the prevention of backflow of the present invention;

FIG. 9 shows an embodiment of the present invention; and

FIG. 10 shows an embodiment of the present invention.

### DETAILED DESCRIPTION OF THE PREFERRED EMBODIMENTS

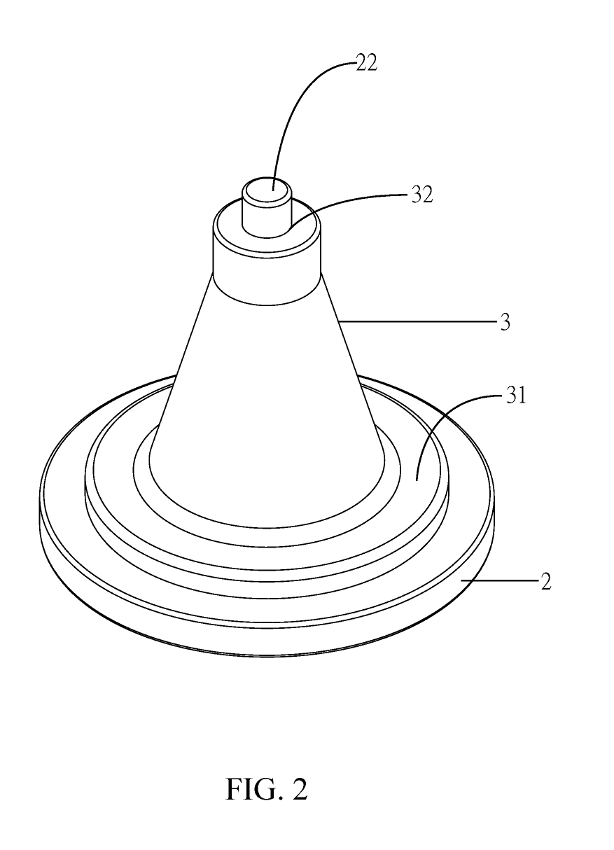

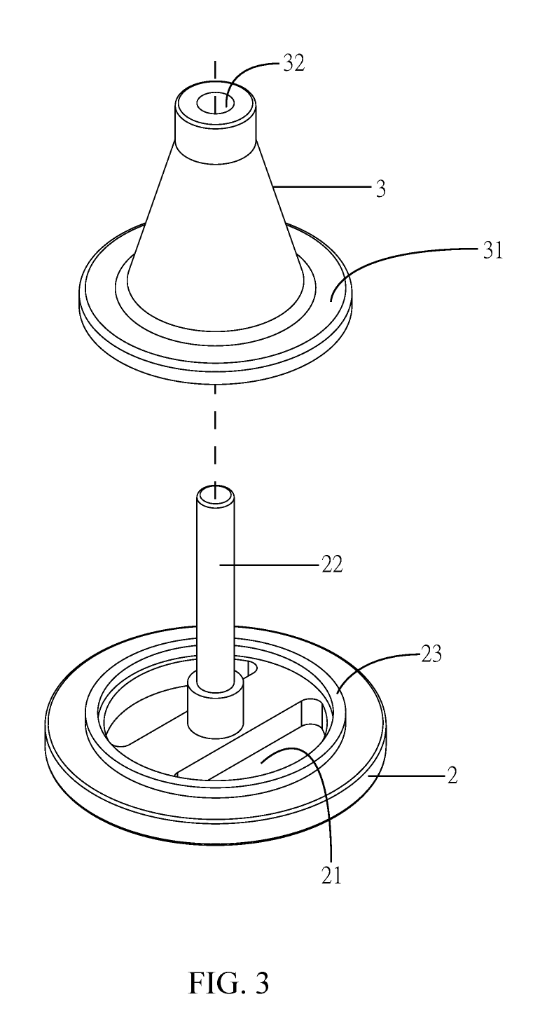

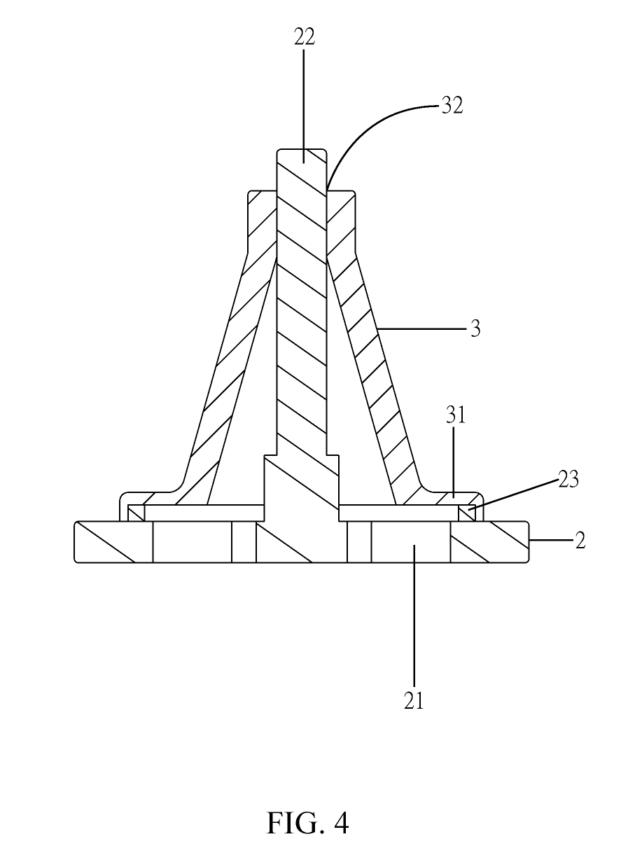

Please refer to FIG. 2 to FIG. 4, showing a perspective view, an exploded view and a cross-sectional view of the present invention. The present invention provides a negative pressure backflow prevention apparatus, comprising a base 2 having one end formed of at least one air inlet 21, and the at least one air inlet 21 penetrate into another end of the base 2. A center of the base 2 includes a supporting 22 and a first connecting portion 23 formed thereon.

The negative pressure backflow prevention apparatus of the present invention further comprises a sealing member 3. The internal of the sealing member 3 is formed of a hollow space. The sealing member 3 includes one end formed of a second connecting portion 31, and the second connecting portion 31 is connected to the first connecting portion 23 in order to seal another end of the at least one air inlet 21. Another end of the sealing member 3 further includes an air outlet 23 formed thereon. The supporting portion 22 penetrates through the air outlet 32 and is attached onto the air outlet 32 and the supporting portion 22.

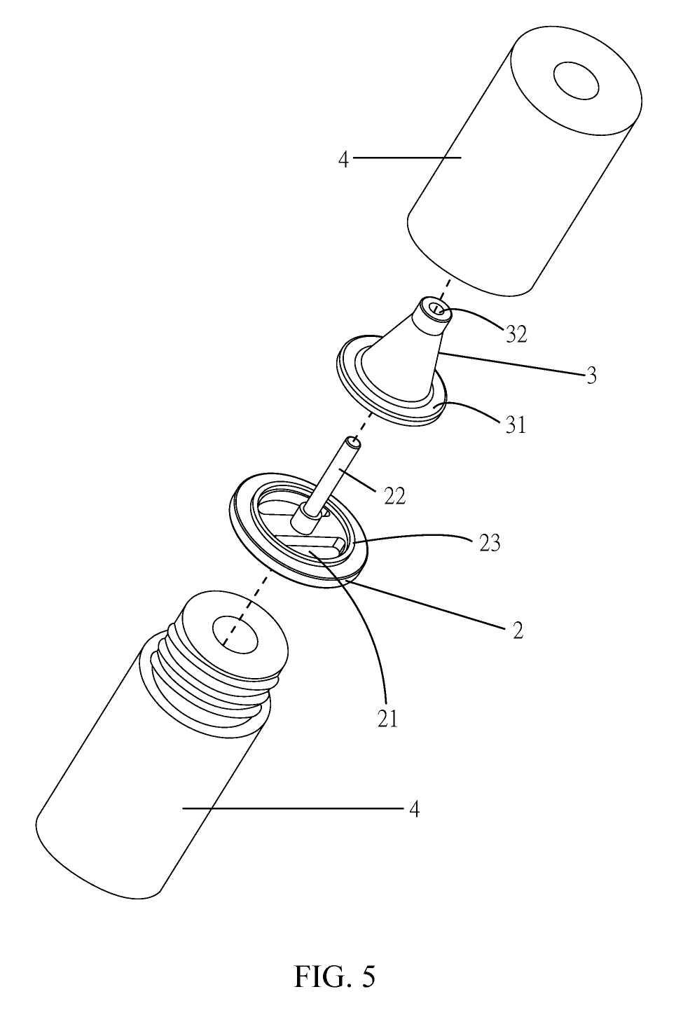

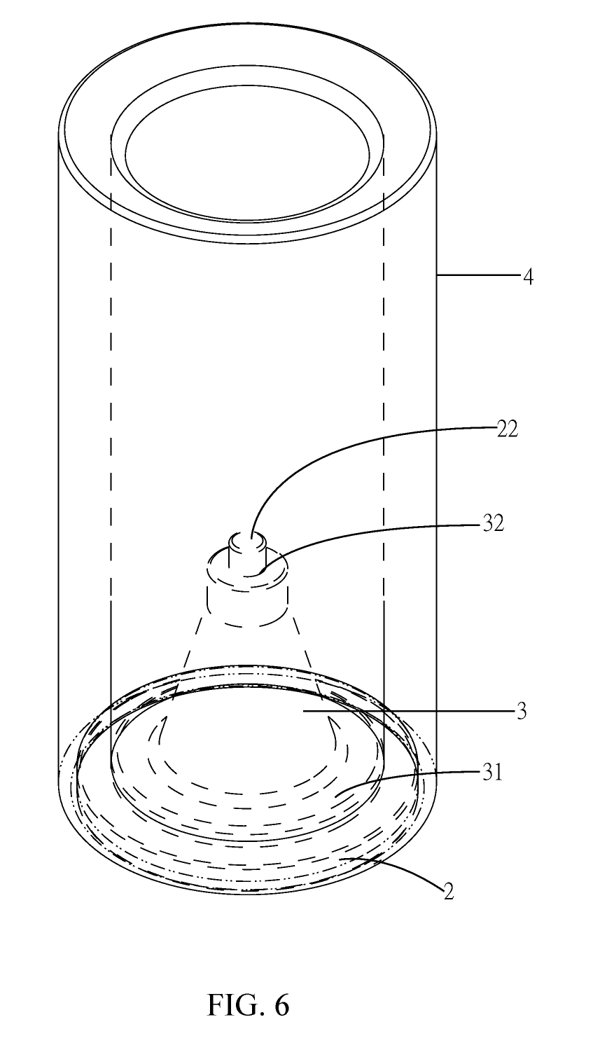

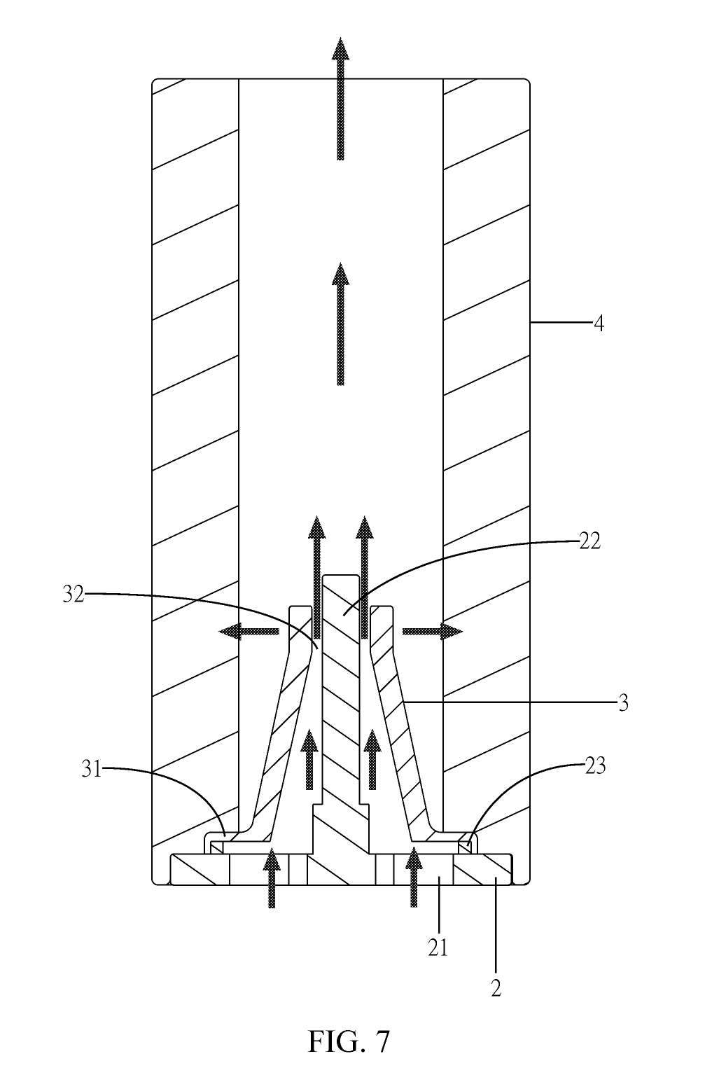

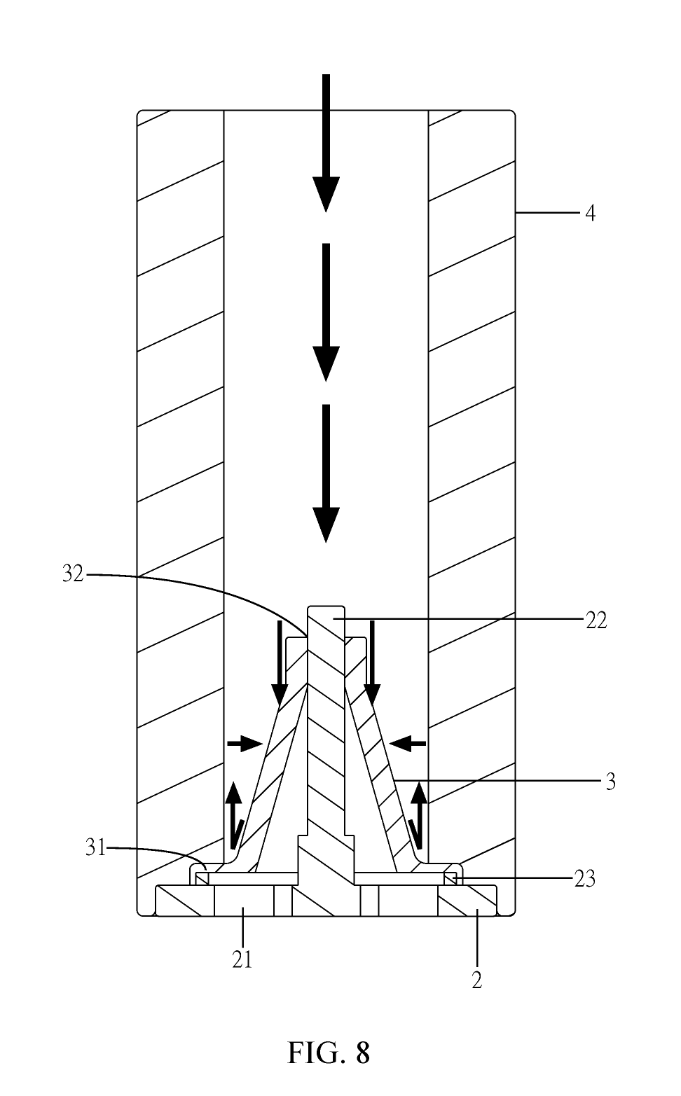

Please refer to FIG. 5 to FIG. 8, showing an exploded view of a state of use, another view of the state of use, an air intake view and a backflow prevention view of the present invention. As shown in the drawings, the base 2 and the sealing member 3 are installed at an internal of an air guide 4. When a gas is introduced from the air inlet 21 formed on one end of the base 2, since the first connecting portion 23 and the second connecting portion 31 are connected to each other to seal the other end of the air inlet 21, the air can only be guided to exit from the air outlet 32 formed on the other end of the sealing member 3. On the other hand, if the air attempts to enter from the air outlet 32, since the air outlet 32 is attached onto the supporting portion 13, the air is blocked at the external of the sealing member 3 without entering into the internal of the sealing member 3. Furthermore, the supporting member 13 is able to effectively support the air outlet 32; therefore, in the event where the air backflow creates a negative pressure to push onto the air outlet 32, the air outlet 32 can be prevented from deformation due to such exertion of pressure. Consequently, the apparatus of the present invention is able to achieve the technical effects of preventing deformations of the apparatus and preventing negative backflows.

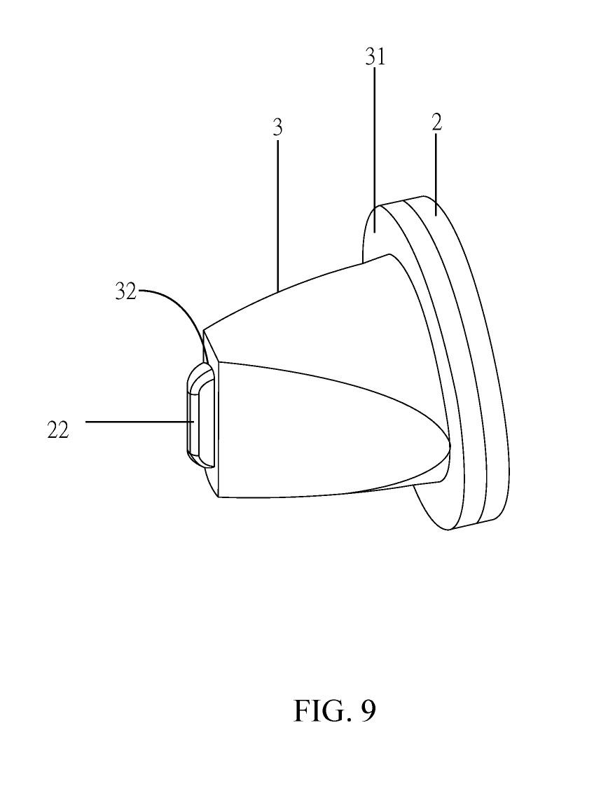

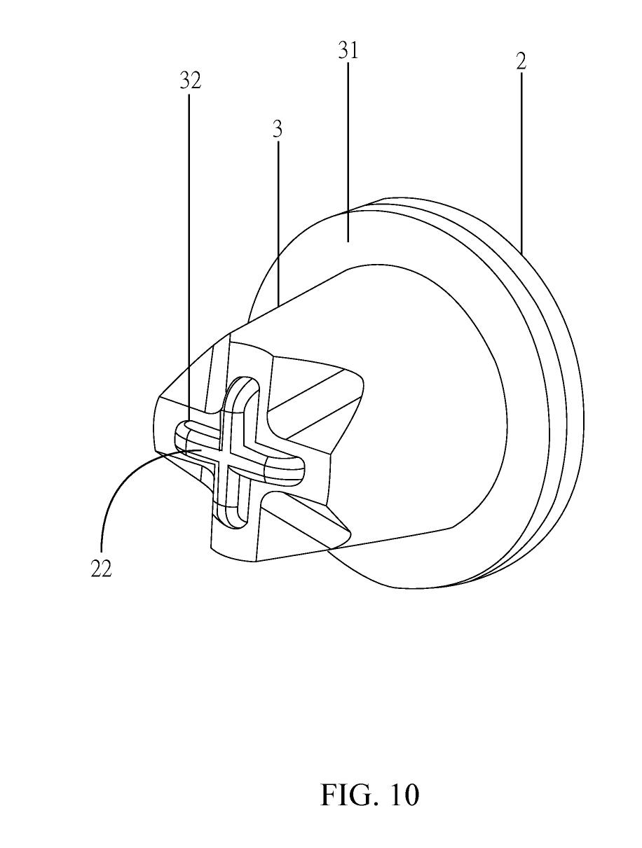

Please refer to FIG. 9 to FIG. 10, showing embodiments of the present invention. As shown in the drawings, the apparatus of the present invention can be constructed by the elements of the shapes of trapezoid, square, triangle or other geometric shapes in three-dimensional forms in order to achieve effects identical to the ones of the present invention.

1. A negative pressure backflow prevention apparatus, comprising:
a base having one end formed of at least one air inlet, a supporting portion having a proximal end mounted to the base and extending from the base in a given direction to define an opposite distal end, and a first connecting portion arranged at predefined locations of the base; the at least one air inlet penetrating into another end of the base to define an inlet opening; and
a sealing member having one end formed of a second connecting portion and another end formed of an air outlet; the second connecting portion and the first connecting portion connected to each other in order to seal said another end of the air inlet; and the supporting portion penetrating through the air outlet;
wherein the sealing member comprises an intermediate section extending from the second connecting portion in a direction toward and jointing with the air outlet such that the air outlet is supported by the intermediate section to selectively engage with the distal end of the supporting portion and wherein the intermediate section is kept consistently away from the supporting portion between the proximal end and the distal end of the supporting portion to define an internal hollow space inside the sealing member for receiving an ingress flow of fluid through the inlet opening.

2. The negative pressure backflow prevention apparatus according to claim 1, wherein the base and the sealing member are further installed at an internal of an air guide in order to effectively guide a gas to a predefined location via the air guide.

3. (canceled)

4. The negative pressure backflow prevention apparatus according to claim 1, wherein a vertical cross-sectional profile the sealing member has a shape of any one of a triangle, a rectangle and a trapezoid.

5. The negative pressure backflow prevention apparatus according to claim 1, wherein a center of the base is formed of the supporting portion and the first connecting portion.

6. The negative pressure backflow prevention apparatus according to claim 5, wherein a horizontal cross-sectional profile of the base has a shape of one of a circle, a triangle, a rectangle and a star.
